(19) United States
(12) Patent Application Publication
(10) Pub. No.: US 2022/0063100 A1
(43) Pub. Date: Mar. 3, 2022

(54) CONTROL APPARATUS

(71) Applicant: KYOCERA Document Solutions Inc., Osaka (JP)

(72) Inventor: Kohei MORIGUCHI, Osaka (JP)

(73) Assignee: KYOCERA Document Solutions Inc., Osaka (JP)

(21) Appl. No.: 17/417,079

(22) PCT Filed: Nov. 6, 2019
(86) PCT No.: PCT/JP2019/043408

§ 371 Date: Jun. 21, 2021

(30) Foreign Application Priority Data
Dec. 28, 2018 (JP) 2018-248505

(51) Int. Cl. B25J 9/16; B25J 13/08

(52) U.S. Cl. CPC B25J 9/1666; B25J 9/1661; B25J 9/1697; B25J 9/1651; B25J 13/089

(57) ABSTRACT

A control apparatus (20) includes a control device (21) and the control device (21) includes: a detector (214) that detects an entering person (P) entering a range (E1) of motion of an arm (11); and a limiter (215) that, upon detection of the entering person (P) entering the range (E1) of motion by the detector (214), sets a behavior prohibition range (E2) of the arm (11) where the arm (11) is kept from coming into contact with the entering person (P), thus limiting a behavior of the arm.

### TECHNICAL FIELD

The present invention relates to a control apparatus that controls the drive of joints constituting parts of a robot arm.

### BACKGROUND ART

While a worker is doing a work in cooperation with a robot, an arm of the robot may come into contact with the worker to cause an accident. As a method for preventing the occurrence of such an accident, there is proposed a method in which when a worker comes close to a robot, the motion of the robot is slowed down or stopped (see Patent Literature 1 below).

### CITATION LIST

### Patent Literature

Patent Literature 1: JP-A-2010-188458

### SUMMARY OF INVENTION

However, if the motion of the robot is slowed down or stopped each time a worker comes close to the robot, the working efficiency deteriorates, so that the productivity may significantly decrease.

The present invention has been made in view of the foregoing circumstances and has an object of ensuring, in the case where a worker comes close to a robot, the safety of the worker without significantly decreasing the productivity.

### Solution to Problem

A control apparatus according to an aspect of the present invention is a control apparatus capable of controlling a motion of a robot, the robot including: an arm equipped with a plurality of joints, supported at one end to a base, and freely movable in a three-dimensional space; and drive devices provided one in each of the plurality of joints to drive the joints, and the control apparatus includes: a behavior planner that makes a behavior plan for the arm; a controller that controls operation of the drive devices according to the behavior plan made by the behavior planner; a detector that detects an entering person entering a range of motion of the arm based on working environment information acquired from a monitor monitoring a working environment of the robot; and a limiter that, upon detection of the entering person entering the range of motion by the detector, sets a behavior prohibition range of the arm where the arm is kept from coming into contact with the entering person, thus limiting a behavior of the arm, wherein when the limiter sets the behavior prohibition range, the behavior planner remakes the behavior plan into a plan that keeps the arm from performing any behavior within the behavior prohibition range and the controller controls the operation of the drive devices according to the behavior plan remade by the behavior planner.

### Advantageous Effects of Invention

According to the present invention, since, upon entry of a person into the range of motion of the arm, a behavior prohibition range is set to limit the behavior of the arm, an accidental contact between the person and the arm can be prevented. Furthermore, there is no need to slow down or stop the motion of the arm as would conventionally be the case, so that a significant decrease in productivity can be avoided. Therefore, the safety of workers can be ensured without significantly decreasing the productivity.

### BRIEF DESCRIPTION OF DRAWINGS

FIG. 1 is a functional block diagram schematically showing an essential internal configuration of a robot control system made up by including a control apparatus according to an embodiment of the present invention.

FIG. 2 is an outline view schematically showing a robot to be controlled.

FIG. 3 is an explanatory view for illustrating the range of motion of an arm.

FIG. 4 is an explanatory view for illustrating a behavior prohibition range of the arm.

FIG. 5 is a flowchart showing an example of a processing operation performed in a control device of a control apparatus according to a first embodiment.

FIG. 6A is an explanatory view for illustrating that the behavior prohibition range is changed stepwise.

FIG. 6B is an explanatory view for illustrating that the behavior prohibition range is changed stepwise.

FIG. 7 is a flowchart showing an example of a processing operation performed in a control device of a control apparatus according to a second embodiment.

FIG. 8 is a functional block diagram schematically showing an essential internal configuration of a robot control system made up by including a control apparatus according to a third embodiment.

FIG. 9 is a functional block diagram schematically showing an essential internal configuration of a robot control system made up by including a control apparatus according to a fourth embodiment.

### DESCRIPTION OF EMBODIMENTS

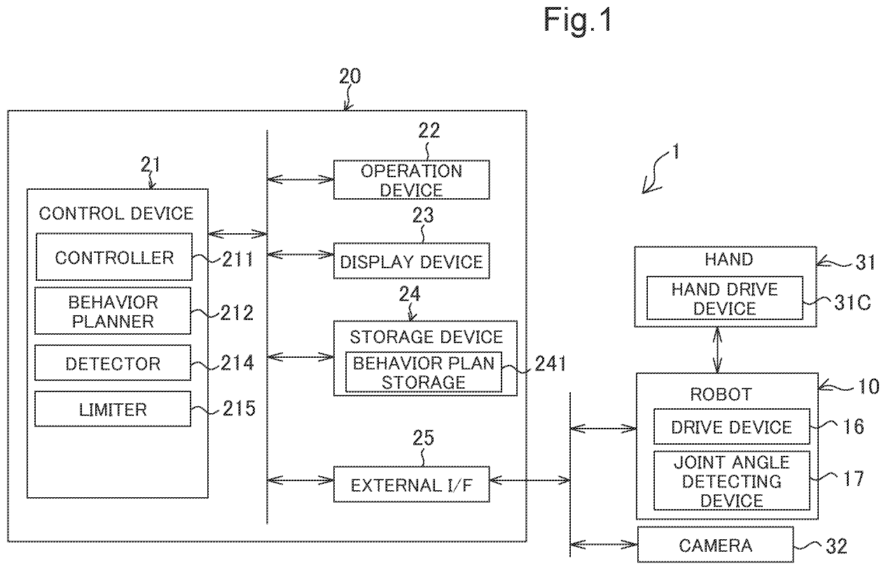

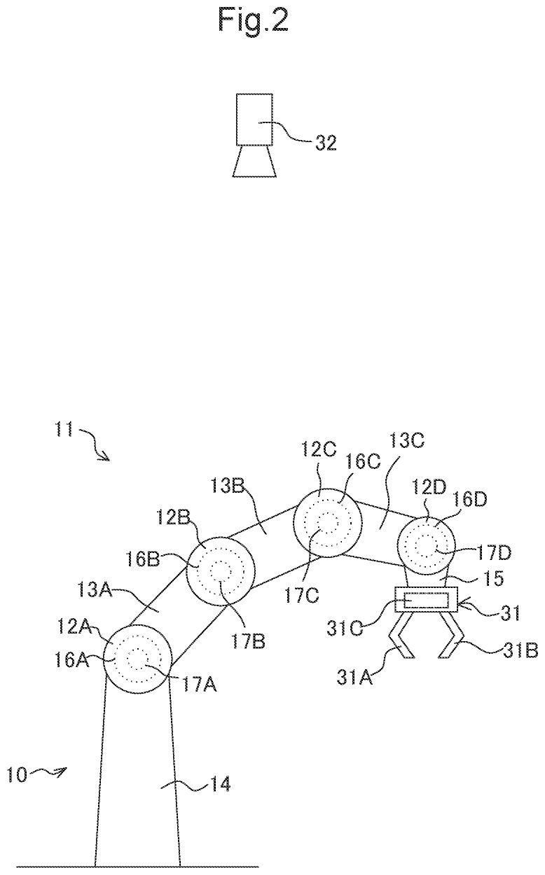

Hereinafter, a description will be given of a control apparatus according to an embodiment of the present invention with reference to the drawings. FIG. 1 is a functional block diagram schematically showing an essential internal configuration of a robot control system made up by including a control apparatus according to a first embodiment. FIG. 2 is an outline view schematically showing a robot to be controlled.

The robot control system 1 is made up by including a robot 10 and a control apparatus 20 capable of controlling the motion of the robot 10.

As shown in FIG. 2, the robot 10 is a manipulator having motor functions similar to those of a human arm and includes an arm (robot arm) 11 freely movable in a three-dimensional space, and one end of the arm 11 is supported on a base 14. The arm 11 includes a plurality of joints 12A to 12D (hereinafter, collectively referred to also as “joints 12”) and links 13A to 13C connecting between the joints 12.

Furthermore, the arm 11 is formed so that, at a distal end 15 thereof, an end effector can be removably and replaceably attached to the distal end 15. In FIG. 2, a hand 31 with two fingers 31A, 31B disposed oppositely is attached as an end effector. The hand 31 is used, for example, for grasping a workpiece to be grasped (picking motion) and carrying the grasped workpiece to a given location (placement motion). The hand 31 has a built-in hand drive device 31C capable of driving the fingers 31A, 31B.

The robot 10 includes: drive devices (joint drive devices) 16A to 16D (hereinafter, collectively referred to also as “drive devices 16”) provided one at each of the joints 12 to drive the joints 12; and joint angle detecting devices 17A to 17D (hereinafter, collectively referred to also as “joint angle detecting devices 17”) provided one at each of the joints 12 to detect the angles of rotation of the joints 12. Furthermore, above the robot 10, a camera 32 is disposed to monitor the working environment for the robot 10. For example, a motor can be cited as an example of the drive device 16 and an encoder can be cited as an example of the joint angle detecting device 17. The camera 32 is an example of a monitor defined in Claims.

The position of the distal end 15 of the arm 11 can be determined from the angles of all of the joints 12A to 12D. Therefore, the joint angle detecting devices 17 play a role as a position detecting device that detects the position of the distal end 15 of the arm 11. It is also possible to use the camera 32 capable of capturing the whole image of the robot 10 as the position detecting device.

The control apparatus 20 includes a control device 21, an operation device 22, a display device 23, a storage device 24, and an external interface device (external I/F) 25.

The operation device 22 is composed of a keyboard, a mouse, and so on and is for inputting commands and characters to the control device 21 and operating a pointer on the screen of the display device 23. The display device 23 is a display device, such as a liquid crystal display (LCD) or an organic light-emitting diode (OLED) display, and displays a response or a data result from the control device 21. The operation device 22 is used to input, for example, instructions for tasks to be performed by the arm 11 and specifically used to input the specification of a position where the distal end 15 of the arm 11 should reach as a target (for example, a position where the arm 11 grasps a workpiece or a position to which the arm 11 carries the grasped workpiece and at which the arm 11 releases it). The position where the arm 11 grasps the workpiece is an end point of a picking motion and the position where the arm 11 releases the workpiece is an end point of a placement motion.

The storage device 24 is a storage device, such as an HDD (hard disk drive), stores programs and data necessary for the operation of the control apparatus 20, and includes a behavior plan storage 241. Stored in the behavior plan storage 241 are behavior plans for the arm 11 made by a behavior planner 212 to be described later.

The external interface device 25 is for connections with external devices. The control apparatus 20 is connected through the external interface device 25 to the drive devices 16 and joint angle detecting devices 17 forming parts of the robot 10 and the camera 32, and is further connected through the robot 10 to the hand drive device 31C.

The control device 21 is made up by including a processor, a RAM (random access memory), a ROM (read only memory), and a dedicated hardware circuit. The processor is, for example, a CPU (central processing unit), an ASIC (application specific integrated circuit) or an MPU (micro processing unit). The control device 21 includes a controller 211, a behavior planner 212, a detector 214, and a limiter 215.

The control device 21 functions as the controller 211, the behavior planner 212, the detector 214, and the limiter 215 by operation of the processor in accordance with a control program stored in the storage device 24. However, each of the above components of the control device 21 may not be implemented by the operation of the control device 21 in accordance with the control program, but may be constituted by a hardware circuit. Hereinafter, the same applies to the other embodiments unless otherwise stated.

The controller 211 governs the overall operation control of the control apparatus 20. The controller 211 is connected to the operation device 22, the display device 23, the storage device 24, and the external interface device 25, controls the operations of these connected components, and transfers signals or data to and from these components.

The behavior planner 212 makes a behavior plan for the arm 11 as a plan for realizing a task or tasks given through the operation device 22 by a user. For example, the behavior planner 212 creates a target trajectory of the distal end 15 of the arm 11, points of operation on the target trajectory, task details at the points of operation, and so on. In creating the target trajectory, various generating algorithms, such as the RRT (rapidly exploring random tree), can be applied.

The controller 211 further controls the operation of the drive devices 16 in accordance with the behavior plan made by the behavior planner 212. For example, the controller 211 controls the operation of the drive devices 16 based on a target trajectory (for example, a target position) created by the behavior planner 212 and the position of the distal end 15 of the arm 11 to allow the distal end 15 to track the target trajectory. The position of the distal end 15 of the arm 11 can be determined from all the angles detected by the joint angle detecting devices 17.

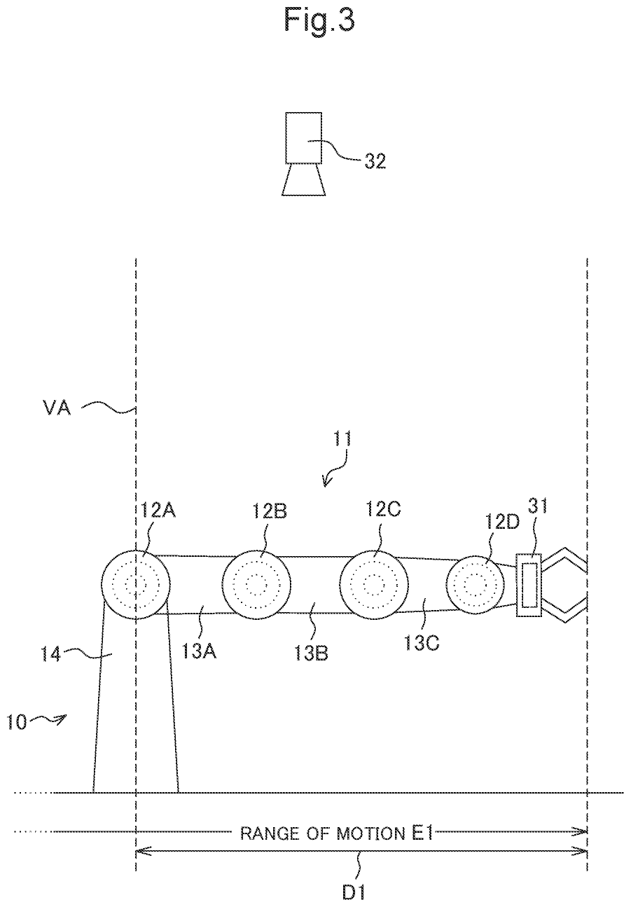

The detector 214 detects a person entering the range E1 (see FIG. 3) of motion of the arm 11 based on working environment information acquired from the camera 32. For example, the detector 214 analyzes image data acquired by image capture with the camera 32 to detect a moving object other than the arm 11 as an entering person. Furthermore, the detector 214 can detect, based on the working environment information acquired from the camera 32, exit of the entering person from the range E1 of motion, whether or not the entering person has moved, and the location where the entering person is.

FIG. 3 is an explanatory view for illustrating the range E1 of motion of the arm 11. The range E1 of motion of the arm 11 is, with the arm 11 stretched out horizontally, the range from an vertical axis VA passing through one end of the arm 11 supported on the base 14 to the distal end of the hand 31 serving as an end effector. Furthermore, the distance D1 represents the distance from the vertical axis VA to the boundary line of the range E1 of motion.

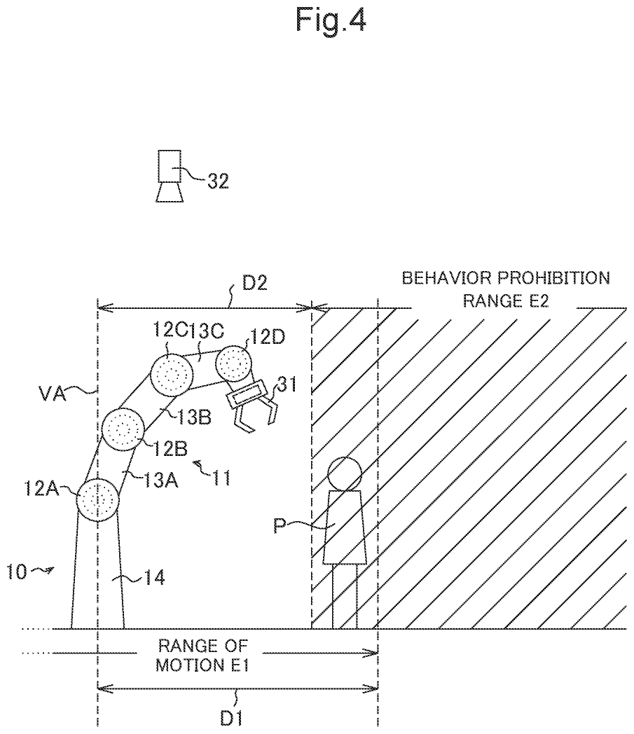

The limiter 215 sets, upon detection of a person entering the range E1 of motion by the detector 214, a behavior prohibition range E2 (see FIG. 4) of the arm 11 where the arm 11 is kept from coming into contact with the entering person, thus limiting the behavior of the arm 11.

FIG. 4 is an explanatory view for illustrating the behavior prohibition range E2 of the arm 11. The behavior prohibition range E2 (the hatched portion in the figure) contains part of the range E1 of motion (i.e., the location where the entering person P is and its surrounding area) to keep the arm 11 from coming into contact with the entering person P having entered the range E1 of motion. Furthermore, the distance D2 represents the distance from the vertical axis VA to the boundary line of the behavior prohibition range E2 and the distance D2 is shorter than the distance D1.

When the behavior prohibition range E2 is set by the limiter 215, the behavior planner 212 remakes the behavior plan into a plan that keeps the arm 11 from performing any behavior within the behavior prohibition range E2. Then, the controller 211 controls the operation of the drive devices 16 in accordance with the behavior plan remade by the behavior planner 212.

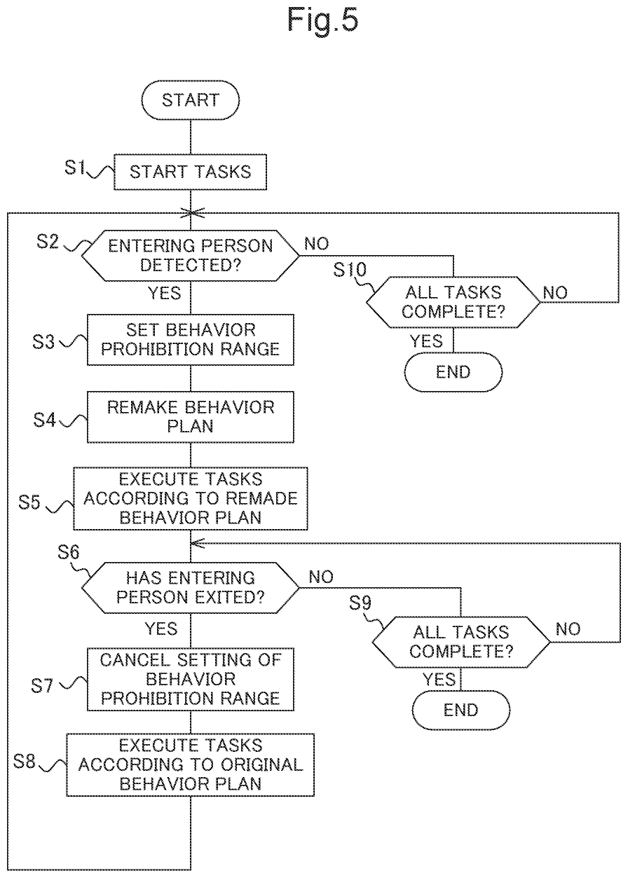

Next, a description will be given of an example of a processing operation performed in the control device 21 of the control apparatus 20 according to the first embodiment, with reference to the flowchart shown in FIG. 5. For example, the processing operation is a processing operation performed in repeating tasks, such as picking and placement.

When the controller 211 controls the operation of the drive devices 16 in accordance with a behavior plan made by the behavior planner 212, thus starting the tasks given by the user (S1), the controller 211 determines whether or not the detector 214 has detected a person P entering the range E1 of motion (S2).

When the controller 211 determines that the detector 214 has detected a person P entering the range E1 of motion (YES in S2), the limiter 215 sets a behavior prohibition range E2 of the arm 11 to limit the behavior of the arm 11 (S3) and the behavior planner 215 remakes the behavior plan for implementing the above tasks into a plan that keeps the arm 11 from performing any behavior within the behavior prohibition range E2 (S4). In doing so, the behavior planner 212 allows the behavior plan storage 241 to store the original behavior plan. Examples of the method for setting the behavior prohibition range E2 include the following three methods.

1. When the detector 214 detects a person P entering the range E1 of motion, the limiter 215 sets a predetermined behavior prohibition range E2.

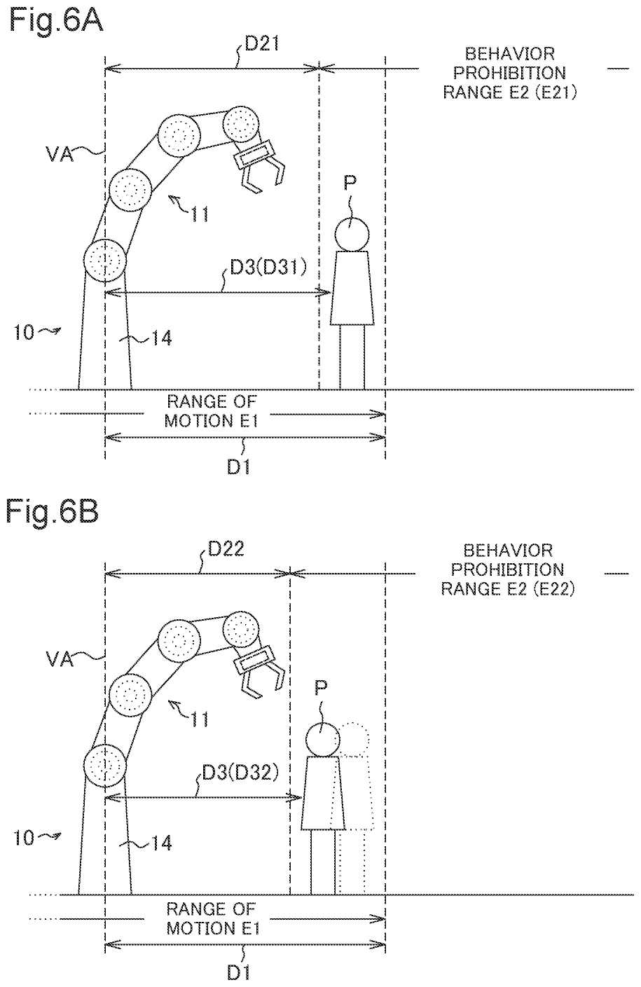

2. A plurality of behavior prohibition ranges E2 are previously prepared according to the distance D3 (see FIGS. 6A and 6B) from the vertical axis VA to the entering person P. The detector 214 detects the distance D3 from the vertical axis VA to the entering person P and the limiter 215 determines one of the behavior prohibition ranges E2 according to the distance D3 and sets the behavior prohibition range E2. In other words, the behavior prohibition range E2 is changed stepwise according to the distance D3.

FIGS. 6A and 6B are explanatory views for illustrating that the behavior prohibition range E2 is changed stepwise. When the distance D3 from the vertical axis VA to the entering person P is a distance D31, the behavior prohibition range E2 is a behavior prohibition range E21 having a distance D21 away from the vertical axis VA as shown in FIG. 6A. When the distance D3 from the vertical axis VA to the entering person P is a distance D32 (<D31), the behavior prohibition range E2 is a behavior prohibition range E22 having a distance D22 (<D21) away from the vertical axis VA as shown in FIG. 6B, so that the range where the arm 11 is allowed to perform behaviors becomes narrower.

3. The detector 214 detects the location where the entering person P is and the limiter 215 determines the location of the entering person P and its surrounding area as a behavior prohibition range E2 and sets the behavior prohibition range E2.

The description above has been given of the case where the limiter 215 sets the behavior prohibition range E2. However, when the distance D3 from the vertical axis VA to the entering person P is equal to or less than a predetermined threshold value (i.e., when the entering person P comes too close to the arm 11), the controller 211 may stop the motion of the arm 11.

Subsequently, the controller 211 controls the operation of the drive devices 16 in accordance with the behavior plan remade by the behavior planner 212 to execute the above tasks (S5), and then determines whether or not the detector 214 has detected exit of the entering person P from the range E1 of motion (S6).

When the controller 211 determines that the detector 214 has detected the exit of the entering person P from the range E1 of motion (YES in S6), the limiter 215 cancels the setting of the behavior prohibition range E2 of the arm 11 (S7), the controller 211 controls the operation of the drive devices 16 in accordance with the original behavior plan stored in the behavior plan storage 241 to execute the above tasks (S8), and then the processing goes back to S2.

On the other hand, when the controller 211 determines that the detector 214 has not detected exit of the entering person P from the range E1 of motion (NO in S6), the controller 211 determines whether or not all of the above tasks have been completed (S9). For example, when a scheduled number of times of picking and placement terminate or when no object to be grasped remains, the controller 211 determines that all of the tasks have been completed. Whether or not no object to be grasped remains can be determined by analyzing image data from the camera 32.

When the controller 211 determines that all of the above tasks have been completed (YES in S9), the controller 211 ends this processing operation. When the controller 211 determines that all of the tasks have not been completed (NO in S9), the processing goes back to S6.

Furthermore, when in S2 the controller 211 determines that the detector 214 has not detected any person P entering the range E1 of motion (NO in S2), the controller 211 determines whether or not all of the above tasks have been completed (S10). When the controller 211 determines that all of the above tasks have been completed (YES in S10), the controller 211 ends this processing operation. When the controller 211 determines that all of the above tasks have not been completed (NO in S10), the processing goes back to S2.

According to the first embodiment, when a person enters the range E1 of motion of the arm 11, the behavior prohibition range E2 is set, so that the behavior of the arm 11 is limited. Therefore, an accidental contact between the person and the arm 11 can be prevented. Furthermore, since it is prevented that the motion of the arm 11 is slowed down or stopped as would conventionally be done, a significant decrease in productivity can be avoided. Therefore, the safety of workers can be ensured without significantly decreasing the productivity.

In limiting the behavior of the arm 11, the entering person P is preferably notified of it. For example, a speaker is provided and, before the behavior prohibition range E2 is set, the controller 211 allows the speaker to sound a guidance “A worker is in the danger area. The range of behavior of the robot will be limited.” or a guidance “The range of behavior of the robot will be limited. If it's inconvenient, please step back.”

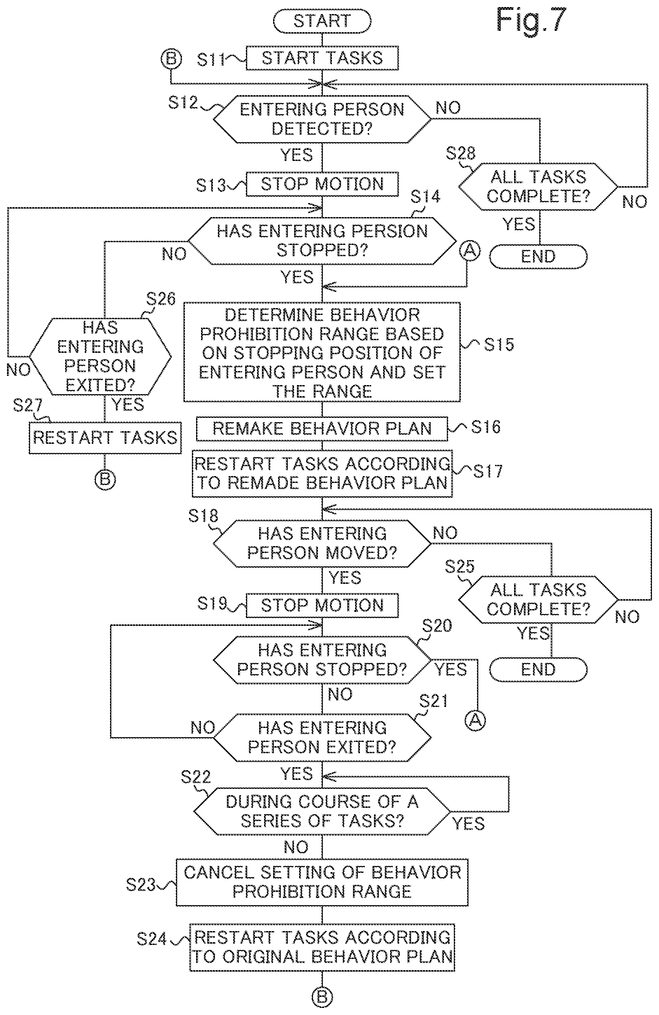

Next, a description will be given of an example of a processing operation performed in the control device 21 of the control apparatus 20 according to a second embodiment, with reference to the flowchart shown in FIG. 7. For example, the processing operation is a processing operation performed in repeating tasks, such as picking and placement.

When the controller 211 controls the operation of the drive devices 16 in accordance with a behavior plan made by the behavior planner 212, thus starting the tasks given by the user (S11), the controller 211 determines whether or not the detector 214 has detected a person P entering the range E1 of motion (S12).

When the controller 211 determines that the detector 214 has detected a person P entering the range E1 of motion (YES in S12), the controller 211 stops the motion of the arm 11 (S13).

Subsequently, the controller 211 determines whether or not the detector 214 has detected stopping of the entering person P (S14). For example, when the moving range of the entering person P is slight continuously over a predetermined period of time, the detector 214 determines that the entering person P is stopping.

When the controller 211 determines that the detector 214 has detected stopping of the entering person P (YES in S14), the limiter 215 determines the behavior prohibition range E2 based on the location of the entering person P detected by the detector 214 (i.e., the stopping position of the entering person P) and sets the behavior prohibition range E2 to limit the behavior of the arm 11 (S15) and the behavior planner 212 remakes the behavior plan for implementing the above tasks into a plan that keeps the arm 11 from performing any behavior within the behavior prohibition range E2 (S16). In doing so, the behavior planner 212 allows the behavior plan storage 241 to store the original behavior plan.

Subsequently, the controller 211 controls the operation of the drive devices 16 in accordance with the behavior plan remade by the behavior planner 212 to restart the above tasks (S17), and then controller 211 determines whether or not the detector 214 has detected movement of the entering person P (S18).

When the controller 211 determines that the detector 214 has detected movement of the entering person P (YES in S18), the controller 211 stops the motion of the arm 11 (S19) and then determines whether or not the detector 214 has detected stopping of the entering person P (S20).

When the controller 211 determines that the detector 214 has detected stopping of the entering person P (YES in S20), the processing goes to S15 and the limiter 215 determines the behavior prohibition range E2 based on the location (the stopping position) of the entering person P detected by the detector 214 and sets the behavior prohibition range E2 (S15) to limit the behavior of the arm 11.

On the other hand, when the controller 211 determines that the detector 214 has not detected stopping of the entering person P (NO in S20), the controller 211 determines whether or not the detector 214 has detected exit of the entering person P from the range E1 of motion (S21).

When the controller 211 determines that the detector 214 has detected exit of the entering person P from the range E1 of motion (YES in S21), the controller 211 determines whether or not the motion of the arm 11 is during the course of a series of tasks (S22).

For example, in the case where picking and placement tasks are repeated and if the present situation is in the middle of one cycle of picking and placement, the controller 211 determines that the motion of the arm 11 is during the course of a series of tasks.

When the controller 211 determines that the motion of the arm 11 is not during the course of a series of tasks (NO in S22), the limiter 215 cancels the setting of the behavior prohibition range E2 of the arm 11 (S23), the controller 211 controls the operation of the drive devices 16 in accordance with the original behavior plan stored in the behavior plan storage 241 to restart the above tasks (S24), and the processing then goes back to S12.

On the other hand, when the controller 211 determines that the motion of the arm 11 is during the course of a series of tasks (YES in S22), the limiter 215 cancels the setting of the behavior prohibition range E2 of the arm 11 (S23) after the completion of the series of tasks (NO in S22).

When in S21 the controller 211 determines that the detector 214 has not detected exit of the entering person P from the range E1 of motion (NO in S21), the processing goes back to S20.

When in S18 the controller 211 determines that the detector 214 has not detected movement of the entering person P (NO in S18), the controller 211 determines whether or not all of the above tasks have been completed (S25). When determining that all of the above tasks have been completed (YES in S25), the controller 211 ends this processing operation. When determining that all of the above tasks have not been completed (NO in S25), the processing goes back to S18.

When in S14 the controller 211 determines that the detector 214 has not detected stopping of the entering person P (NO in S14), the controller 211 determines whether or not the detector 214 has detected exit of the entering person P from the range E1 of motion (S26).

When the controller 211 determines that the detector 214 has detected exit of the entering person P from the range E1 of motion (YES in S26), the controller 211 restarts the above tasks (S27) and the processing then goes back to S12.

On the other hand, when the controller 211 determines that the detector 214 has not detected exit of the entering person P from the range E1 of motion (NO in S26), the processing goes back to S14.

Furthermore, when in S12 the controller 211 determines that the detector 214 has not detected any person P entering the range E1 of motion (NO in S12), the controller 211 determines whether or not all of the above tasks have been completed (S28). When the controller 211 determines that all of the above tasks have been completed (YES in S28), the controller 211 ends this processing operation. When the controller 211 determines that all of the above tasks have not been completed (NO in S28), the processing goes back to S12.

According to the second embodiment, when a person enters the range E1 of motion of the arm 11, the motion of the arm 11 is first stopped. Therefore, the safety of workers can be more certainly ensured. Furthermore, since the behavior prohibition range E2 is determined based on the stopping position of the entering person P, the behavior prohibition range E2 can be minimized. Therefore, the decrease in productivity can be minimized while the safety of workers can be ensured.

The description in this embodiment has been given of the case where, upon entry of a person into the range E1 of motion, the controller 211 stops the motion of the arm 11. However, in another embodiment, the controller 211 may slow down the moving speed of the arm 11.

In still another embodiment, the detector 214 may detect entry of a person into a predetermined caution area around the range E1 of motion based on the working environment information acquired from the camera 32 and, upon detection of entry of a person into the caution area by the detector 214, the controller 211 may slow down the moving speed of the arm 11. For example, the controller 211 slows down the moving speed of the arm 11 to a lower moving speed than before the detector 214 detects the entry of the person into the caution area.

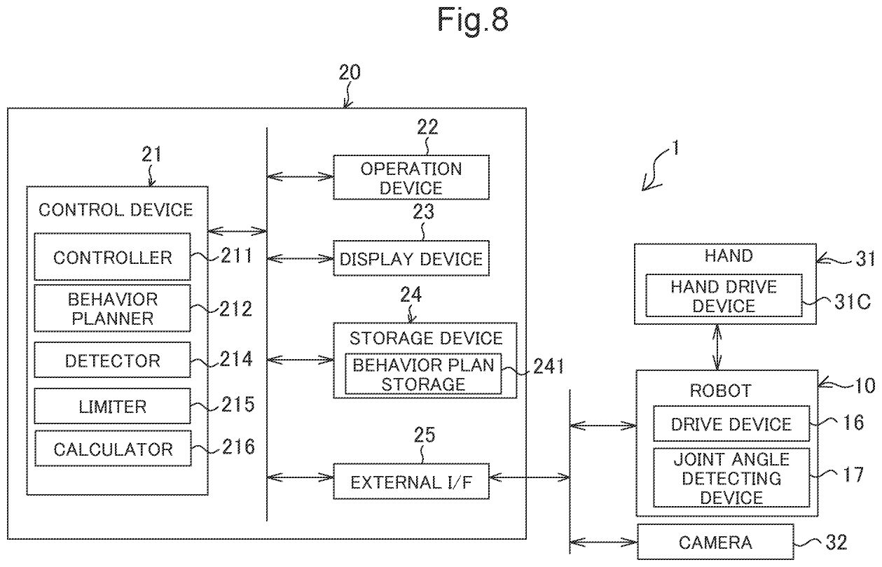

FIG. 8 is a functional block diagram schematically showing an essential internal configuration of a robot control system made up by including a control apparatus according to a third embodiment. The control apparatus according to the third embodiment is different from the control apparatus shown in FIG. 1 in that the control device 21 includes a calculator 216.

When the detector 214 detects a person P entering the range E1 of motion, the calculator 216 calculates, based on the behavior plan running at the time of detection and the location where the entering person P is, a remaining time T before contact between the arm 11 and the entering person P.

When the remaining time T calculated by the calculator 216 reaches a predetermined time T1 (for example, 5 minutes) or below, the limiter 215 sets the behavior prohibition range E2 to limit the behavior of the arm 11. However, unless the remaining time T reaches the predetermined time T1, the limiter 215 avoids limiting the behavior of the arm 11. In other words, even when a person has entered the range E1 of motion, if enough time is allowed, the limiter 215 does not limit the behavior of the arm 11.

According to the third embodiment, when the entering person P exits the range El1 of motion before the remaining time T reaches the predetermined time T1, the behavior of the arm 11 is not limited. Therefore, a decrease in productivity can be prevented.

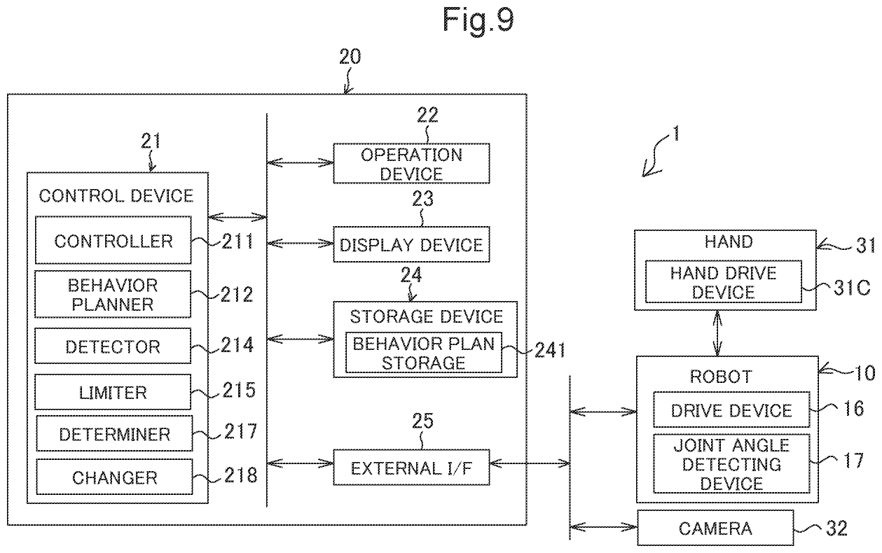

FIG. 9 is a functional block diagram schematically showing an essential internal configuration of a robot control system made up by including a control apparatus according to a fourth embodiment. The control apparatus according to the fourth embodiment is different from the control apparatus shown in FIG. 1 in that the control device 21 includes a determiner 217 and a changer 218.

When the detector 214 detects a person P entering the range E1 of motion, the determiner 217 determines whether or not there is a possibility of contact between the arm 11 and the entering person P, based on the behavior plan running at the time of detection and the location where the entering person P is.

When the determiner 217 determines that there is no possibility of contact between the arm 11 and the entering person P, the limiter 215 avoids setting the behavior prohibition range E2.

When the determiner 217 determines that there is a possibility of contact between the arm 11 and the entering person P, the determiner 217 further determines, based on a behavior plan for a different task from the task running at the time of detection and the location where the entering person P is, whether or not there is a possibility of contact between the arm 11 and the entering person P if the behavior plan for the different task is executed. The behavior plan for the different task may be previously made and stored in the behavior plan storage 241.

When the determiner 217 determines that there is no possibility of contact between the arm 11 and the entering person P even if the different behavior plan is executed, the changer 218 changes the task to be executed to the above different task.

When the changer 218 changes the task to be executed, the limiter 215 avoids setting the behavior prohibition range E2.

According to the fourth embodiment, in the case where there is no possibility of contact between the arm 11 and the entering person P even if the behavior prohibition range E2 is not set, the behavior of the arm 11 is not limited. On the other hand, if there is a possibility of contact between the arm 11 and the entering person P, the task to be executed is changed to a different task having no possibility of the contact. Therefore, a decrease in productivity can be prevented while the safety of workers can be ensured.

Alternatively, the control apparatus may further include a learner that learns the behavior prohibition range E2 and the timing to set the behavior prohibition range E2 and the learner may learn a pattern of behavior of an entering person P and appropriately adjust, based on the learning result, the behavior prohibition range E2 and the timing to set the behavior prohibition range E2.

The present invention is not limited to the above embodiments and can be modified in various ways. The structures, configurations, and processing described in the above embodiments with reference to FIGS. 1 to 9 are merely illustrative of the present invention and are not intended to limit the present invention to the above structures, configurations, and processing.

1. A control apparatus capable of controlling a motion of a robot including: an arm equipped with a plurality of joints, supported at one end to a base, and freely movable in a three-dimensional space; and drive devices provided one in each of the plurality of joints to drive the joints, the control apparatus comprising:
a behavior planner that makes a behavior plan for the arm;
a controller that controls operation of the drive devices according to the behavior plan made by the behavior planner;
a detector that detects an entering person entering a range of motion of the arm based on working environment information acquired from a monitor monitoring a working environment of the robot; and
a limiter that, upon detection of the entering person entering the range of motion by the detector, sets a behavior prohibition range of the arm where the arm is kept from coming into contact with the entering person, thus limiting a behavior of the arm,
wherein when the limiter sets the behavior prohibition range, the behavior planner remakes the behavior plan into a plan that keeps the arm from performing any behavior within the behavior prohibition range and the controller controls the operation of the drive devices according to the behavior plan remade by the behavior planner.

2. The control apparatus according to claim 1, wherein
the detector detects a distance from a vertical axis passing through the one end of the arm to the entering person, and
the limiter determines the behavior prohibition range according to the distance and sets the behavior prohibition range.

3. The control apparatus according to claim 2, wherein when the distance is equal to or smaller than a predetermined threshold value, the controller stops motion of the arm.

4. The control apparatus according to claim 1, wherein
when the detector detects the entering person entering the range of motion, the controller stops the motion of the arm and, upon subsequent stopping of the entering person, the controller restarts the motion of the arm,
the detector detects a stopping position of the entering person, and
the controller determines the behavior prohibition range based on the stopping position of the entering person detected by the detector and sets the behavior prohibition range.

5. The control apparatus according to claim 1, wherein
the detector detects exit of the entering person from the range of motion,
when the detector detects the exit of the entering person from the range of motion, the limiter cancels setting of the behavior prohibition range, and
when the detector detects the exit of the entering person while the motion of the arm is during a course of a series of tasks, the limiter cancels the setting of the behavior prohibition range after the series of tasks are completed.

6. The control apparatus according to claim 1, wherein
the detector detects a location where the entering person is,
the control apparatus further comprises a calculator that, upon detection of the entering person entering the range of motion by the detector, calculates, based on the behavior plan running at the time of detection and the location where the entering person is, a remaining time before contact between the arm and the entering person,
when the remaining time calculated by the calculator reaches a predetermined time or below, the limiter sets the behavior prohibition range to limit the behavior of the arm, and
unless the remaining time reaches the predetermined time, the limiter avoids limiting the behavior of the arm.

7. The control apparatus according to claim 1, wherein
the detector detects a location where the entering person is,
the control apparatus further comprises a determiner that, upon detection of the entering person entering the range of motion by the detector, determines whether or not there is a possibility of contact between the arm and the entering person, based on the behavior plan running at the time of detection and the location where the entering person is, and
when the determiner that there is no possibility of the contact, the limiter avoids setting the behavior prohibition range.

8. The control apparatus according to claim 7, wherein
when the determiner determines that there is a possibility of the contact, the determiner determines, based on a different behavior plan for a different task from a task running at the time of detection and the location where the entering person is, whether or not there is a possibility of contact between the arm and the entering person if the different behavior plan for the different task is executed,
the control apparatus further comprises a changer that, upon determination of the determiner that there is no possibility of contact between the arm and the entering person even if the different behavior plan is executed, changes a task to be executed to the different task, and
when the changer changes the task to be executed, the limiter avoids setting the behavior prohibition range.

9. The control apparatus according to claim 1, wherein
the monitor is a camera, and
the detector analyzes image data acquired by image capture with the camera to detect a moving object other than the arm as the entering person.

10. The control apparatus according to claim 1, wherein
the detector detects entry of a person into a predetermined caution area around the range of motion of the arm based on the working environment information acquired from the monitor, and
when the detector detects the entry of a person into the caution area, the controller slows down a moving speed of the arm to a lower moving speed than before the detector detects the entry of the person into the caution area.
